(19) United States
(12) Patent Application Publication
(10) Pub. No.: US 2026/0264846 A1
(43) Pub. Date: Sep. 10, 2026

(54) Ballast Mount for Battery and Battery Assembly Including Ballast Mount

(71) Applicant: John P. KOCHY, Middlefield, OH (US)

(72) Inventor: John P. KOCHY, Middlefield, OH (US)

(21) Appl. No.: 19/556,109

(22) Filed: Mar. 4, 2026

Related U.S. Application Data
(60) Provisional application No. 63/768,271, filed on Mar. 7, 2025.

(51) Int. Cl. B64C 17/08; B64C 1/14; B64C 27/04; B64D 41/00; H01M 10/0525; H01M 50/249

(52) U.S. Cl. CPC B64C 17/08; B64C 1/14; B64C 27/04; B64D 41/00; H01M 10/0525; H01M 50/249; H01M 2220/20

(57) ABSTRACT

In one general aspect, a battery assembly can include: a battery for supplying power to one or more systems of a vehicle; a ballast mount configured to be mounted on a support surface of the vehicle, and including an interior space configured to receive one or more weight members; and a battery mount mounted on the ballast mount, and configured to retain the battery. In another general aspect, a battery assembly can include: a battery for supplying power to one or more systems of a vehicle; and a ballast mount configured to retain the battery. The ballast mount can be further configured to be mounted on a support surface of the vehicle, and can include a hollow container including an interior space configured to receive one or more weight members.

### RELATED APPLICATIONS

This application claims priority to, and the benefit of, U.S. Provisional Application No. 63/768,271 filed on Mar. 7, 2025, the disclosure of which is incorporated herein by reference in its entirety.

### BACKGROUND

### 1. Field

The following description relates to ballast mount for a battery and a battery assembly including such a ballast mount. More specifically, in one aspect, the following description relates to a ballast mount for a battery, such as a lithium ion battery, for use in an aircraft or other vehicle.

### 2. Description of Related Art

Aircraft generally employ batteries to supply power to various systems of the aircraft. Lead acid and Ni-Cad batteries are commonly used in aircraft applications. All aircraft need to operate within a certain center of gravity (CG) range, and the CG of aircraft can be significantly affected by the placement of the battery in the aircraft. Aircraft engineers commonly use the placement of the battery to change the CG. The battery would be mounted as far forward as possible in the nose of an aircraft that was tail heavy and as far aft as possible in the aircraft for a nose heavy aircraft.

Aircraft operators often add, remove or change equipment and change the position of equipment. The changes affect the weight of the aircraft and CG. To overcome this additional weight load, lead or other weights (e.g., plates) are added or removed from the aircraft to bring the CG back into balance. The ability to add weights can be impeded, however, by the lack of available space and the lack of a proper mounting system.

Lithium ion batteries have been installed to replace lead acid and Ni-Cad batteries in helicopters and other aircraft. Such lithium ion batteries typically weigh less than lead acid or Ni-Cad batteries that are predominately used today. Such replacement of lead acid and Ni-Cad batteries in aircraft, particularly helicopters, with lithium ion batteries causes additional CG/weight Redistribution Problems.

For example when a 16-lb lithium ion battery is installed to replace a 43-lb lead acid battery in an aircraft, this causes a 27-lb weight delta 27 lbs. of lead at the same installation location of the original battery or at other locations put the aircraft back into its previous CG range. The aircraft may already have a way to add or remove weights for or aft to adjust the CG. It is not likely, though, that the existing provisions for adding or removing weight to adjust the CG would be enough to bring the aircraft into SG. There is therefore a need to design a way add additional lead in other areas of the aircraft, which typically has little to no room for any lead to be added. Additionally, in current solutions for adjusting CG, if a suitable location for adding weight is found, engineering work is required to properly secure the weight lead to the aircraft structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Solutions for maintaining a prescribed center of gravity (CG) range in a vehicle when replacing a battery in the vehicle. The solutions disclosed herein are particularly applicable to aircraft, and even more particularly, to helicopters. However, the disclosed solutions are also relevant to other aircraft (e.g., airplanes), land-based vehicles (e.g., automobiles), and water-based vehicles (e.g., boats).

According to embodiments disclosed herein, a battery assembly can include a battery and a ballast mount for mounting the battery to a support surface of a vehicle. The ballast mount can be loaded with weight members to being a CG of the vehicle to a desired range. The disclosed battery assembly can allow a mechanic or other user to compensate for a weight difference between a battery in the battery assembly and the and a weight of an existing battery of the aircraft that is to be replaced by the battery of the battery assembly. Additionally, the battery assembly allows a mechanic or other user to compensate for changes to the CG of the vehicle due to changes in the weight and/or weight distribution of occupants, equipment, and accessories that may occur after the battery assembly is installed, by adding weight members in the ballast mount or removing weight members from the ballast mount.

In one general aspect, a battery assembly can include: a battery for supplying power to one or more systems of a vehicle; a ballast mount configured to be mounted on a support surface of the vehicle, and comprising an interior space configured to receive one or more weight members; and a battery mount mounted on the ballast mount, and configured to retain the battery.

In some embodiments, battery can be a lithium ion battery.

In some embodiments, the ballast mount can further include a door configured to be opened for loading the one or more weight members into the interior space.

In some embodiments, the ballast mount can further include: a bottom panel configured to interface with the support surface of the vehicle; a top panel configured to support the battery mount thereon; side panels connected to the top wall and the bottom wall; and at least one end panel connected to the top panel, the bottom panel, and the side panel.

In some embodiments, the top panel can be inclined with respect to the bottom panel.

In some embodiments, the ballast mount can further include an internal support wall disposed in a central region of the interior space. The internal support wall can be connected to the top panel and the bottom panel.

In some embodiments, the internal support wall can be further connected to the at least one end panel.

In some embodiments, the battery mount can include: a tray interfacing with a top panel of the ballast mount, the tray being configured to receive a bottom panel of the battery; a cross bar configured to interface with a top panel of the battery; and side arms configured connect the cross bar to the tray.

In some embodiments, the one or more weight members can include spherical members or pellets.

In another general aspect, an assembly for installation in a vehicle can include a device and a ballast mount configured to retain the device. The ballast mount can be further configured to be mounted on a support surface of the vehicle. The ballast mount can include a hollow container including an interior space configured to receive one or more weight members.

In some embodiments, the device can include any one of avionics, a pumps, and a rack.

In another general aspect, a ballast box for installation in a vehicle to adjust a center of gravity of the vehicle can include an interior space and one or more weight members received in the interior space. The ballast box can be shaped and dimensioned to be installed in a battery compartment of the vehicle.

In some embodiments, the one or more weight members can include lead shot or steel shot.

In some embodiments, the vehicle can be an aircraft.

In another general aspect, a battery assembly can include: a battery for supplying power to one or more systems of a vehicle; and a ballast mount configured to retain the battery. The ballast mount can be further configured to be mounted on a support surface of the vehicle, and can include a hollow container including an interior space configured to receive one or more weight members.

In some embodiments, the battery can be a lithium ion battery.

In some embodiments, the hollow container can further include a door configured to be opened for loading the one or more weight members into the interior space.

In some embodiments, the hollow container can further include: a bottom panel configured to interface with the support surface of the vehicle; a top panel configured to support the battery thereon; side panels connected to the top wall and the bottom wall; and at least one end panel connected to the top panel, the bottom panel, and the side panels.

In some embodiments, the top panel can be inclined with respect to the bottom panel.

In some embodiments, the ballast mount can further include an internal support wall disposed in a central region of the interior space. The internal support wall can be connected to the top panel and the bottom panel.

In some embodiments, the internal support wall can be further connected to the at least one end panel.

In some embodiments, the ballast mount can further include: a cross bar configured to interface with a top panel of the battery; and side arms configured connect the cross bar to the hollow container and the support surface.

In some embodiments, the one or more weight members can include spherical members or pellets.

In another general aspect, a battery mounting assembly can include: a ballast mount configured to be mounted on a support surface of a vehicle, and including an interior space configured to receive one or more weight members; and a battery mount mounted on the ballast mount, and configured to retain a battery for supplying power to one or more systems of a vehicle.

In another general aspect, a battery mounting assembly can include a ballast mount configured to retain a battery for supplying power to one or more systems of a vehicle. The ballast mount can be configured to be mounted on a support surface of the vehicle, and can include a hollow container including an interior space configured to receive one or more weight members.

In another general aspect, a battery assembly for an aircraft can include: a lithium ion battery for supplying power to one or more systems of the aircraft; and a stainless steel enclosure configured to enclose the lithium ion battery therein.

In some embodiments, the stainless steel enclosure can include a bottom case and a lid configured to be secured to a top of the bottom case.

Other features and aspects will be apparent from the following detailed description, the drawings, and the claims.

### BRIEF DESCRIPTION OF DRAWINGS

FIG. 1A is a side perspective view of a battery assembly, according to an embodiment.

FIG. 1B is a section view taken along line A-A of FIG. 1A.

FIG. 1C is a rear view of the battery assembly of FIG. 1A.

FIG. 1D is an exploded view of the battery assembly of FIG. 1A.

FIG. 2A is a side perspective of a battery assembly, according to an embodiment.

FIG. 2B is a rear perspective view of the battery assembly of FIG. 2A.

FIG. 2C is a side perspective of the battery assembly of FIG. 2A, in which a battery tray in which the battery assembly is mounted is shown partially removed.

FIG. 2D is an exploded view of the battery assembly of FIG. 2A.

FIG. 3A is a front perspective view of a battery assembly, according to an embodiment.

FIG. 3B is a side perspective view of the battery assembly of FIG. 3A.

FIG. 3C is a transparent section view taken along line C-C of FIG. 3A.

FIG. 3D is a rear view of the battery assembly of FIG. 3A with a portion of a battery tray removed.

FIGS. 3E and 3F are side perspective views of the battery assembly of FIG. 3A with the battery tray removed.

FIG. 4 is a front perspective view of a battery assembly, according to an embodiment.

FIG. 5A is a side perspective view of a battery assembly, according to an embodiment.

FIG. 5B is another side perspective view of a battery assembly of FIG. 5A.

FIG. 5C is a rear view of the battery assembly of FIG. 5A.

FIG. 5D is a front view of the battery assembly of FIG. 5A.

FIG. 5E is a side perspective view of ballast mount members of the battery assembly of FIG. 5A.

FIG. 5F is another side perspective view of ballast mount members of the battery assembly of FIG. 5A.

FIG. 6A is a side perspective view of a battery assembly, according to an embodiment.

FIG. 6B is a front perspective view of the battery assembly of FIG. 6A.

FIG. 6C is a rear perspective view of the battery assembly of FIG. 6A.

FIG. 6D is a bottom perspective view of the battery assembly of FIG. 6A.

FIG. 6E is a side view of the battery assembly of FIG. 6A.

FIG. 7A is a side perspective view of a battery assembly, according to an embodiment.

FIG. 7B is a section view taken along line D-D of FIG. 7A.

FIG. 7C is a rear view of the battery assembly of FIG. 7A.

FIG. 7D is an exploded view of the battery assembly of FIG. 7A.

FIG. 8A is a side perspective view of a ballast box, according to an embodiment.

FIG. 8B is a section view taken along line E-E of FIG. 8A.

FIG. 8C is a rear view of the ballast box of FIG. 8A.

FIG. 8D is an exploded view of the ballast box of FIG. 8A.

FIG. 9A is a partial perspective illustrating first and second battery compartments of a helicopter, according to an embodiment.

FIG. 9B is a detailed view of the first battery compartment of FIG. 9A.

FIG. 9C is a detailed view of the second battery compartment of FIG. 9A.

FIG. 10A is a perspective view illustrating a first battery compartment of an airplane, according to an embodiment.

FIG. 10B is an enlarged view of the first battery compartment of FIG. 10A.

FIG. 10C is a is a perspective view illustrating a second battery compartment of an airplane, according to an embodiment.

FIG. 10D is an enlarged view of the second battery compartment of FIG. 10C.

FIG. 11A is a side perspective view of a battery assembly, according to an embodiment.

FIG. 11B is a section view taken along line F-F of FIG. 11A.

FIG. 11C is a rear view of the battery assembly of FIG. 11A.

FIG. 11D is a bottom perspective view of the battery assembly of FIG. 11A.

FIG. 12A is a side perspective view of a battery assembly, according to an embodiment.

FIG. 12B is a section view taken along line G-G of FIG. 12A.

FIG. 12C is a rear view of the battery assembly of FIG. 12A.

FIG. 12D is a bottom perspective view of the battery assembly of FIG. 12A.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

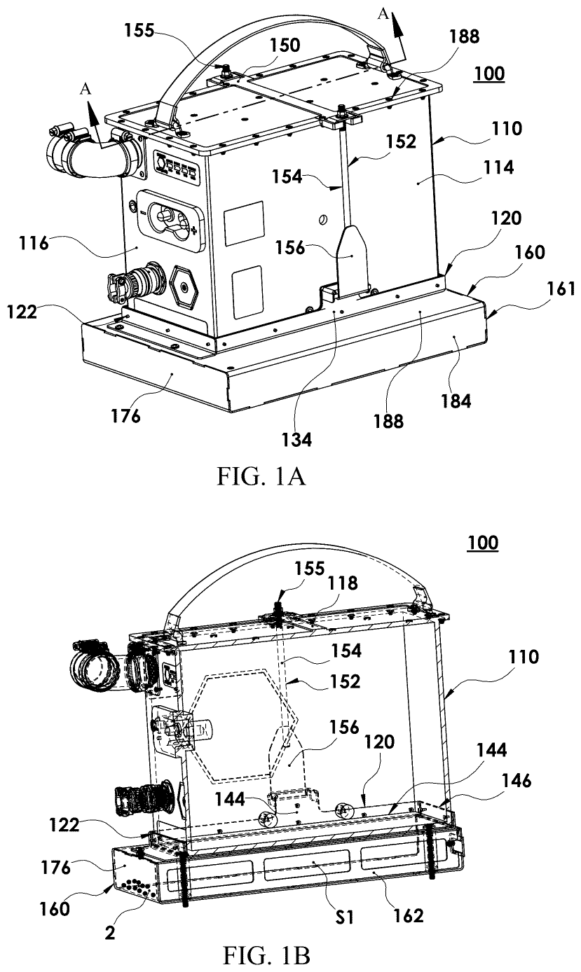

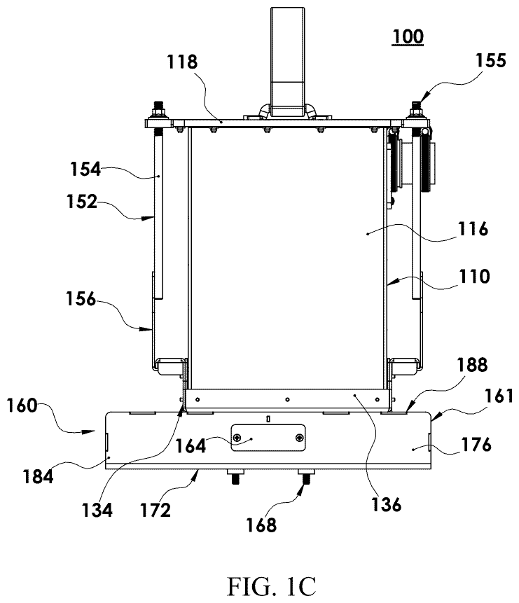

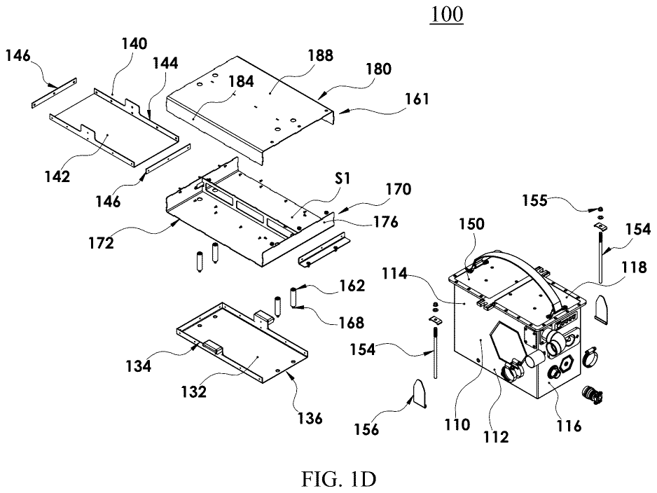

FIGS. 1A to 1D illustrate a battery assembly 100, according to an embodiment. The battery assembly 100 can be configured for installation in a vehicle. For example, the vehicle can be an aircraft. More specifically, in some implementations, the vehicle can be an airplane or a helicopter. However, the vehicle is not limited to an aircraft, and may be any other type of vehicle, such as an automobile or boat.

As shown in FIGS. 1A to 1D, the battery assembly 100 includes a battery 110, a battery mount 120, and a ballast mount 160. The ballast mount 160 is configured to be mounted on a support surface of the vehicle. The battery mount 120 is mounted on the ballast mount 160, and retains the battery 110 on the ballast mount 160.

The battery 110 can be configured to supply power to one or more systems of the vehicle. As an example, the battery 110 can be a lithium-ion battery. In the embodiment of FIGS. 1A and 1B, the battery 110 can be a 30 amp-hour lithium-ion battery. Thus, the battery assembly 100 can be suitable for 30 amp-hour lithium-ion battery installations in various aircraft or other vehicles. However, the battery 110 is not limited to a 30 amp-hour lithium-ion battery, and the battery assembly 100 is not limited to installations of such a battery.

The battery mount 120 is a tray structure configured to secure the battery 110 in position on the ballast mount 160. More specifically, the battery mount 120 can be configured to secure the battery 110 on a top panel 188 of the ballast mount 160. Referring to FIG. 1D, the battery mount 120 can include an outer tray 130 and an inner tray 140 accommodated in the outer tray 130. The outer tray 130 can include a bottom panel 132 that interfaces with and is supported on the top panel 188 of the ballast mount 160, and side panels 134 and end panels 136 extending vertically from the bottom panel 132. The inner tray 140 can include a bottom panel 142 that interfaces with and is supported on the bottom panel 132 of the outer tray 130, and side panels 144 and end panels 146 extending vertically from the bottom panel 142 to reinforce the side panels 134 and end panels 136 of the bottom tray 130, respectively. The bottom panels 132 and 142 support a bottom panel 112 of the battery 112, and the side panels 134 and 144 and the end panels 136 and 146 respectively retain side panels 114 and end panels 116 of the battery 110.

Referring to FIGS. 1A to 1D, the battery mount 120 further includes a cross bar 150 configured to interface with and retain a top panel 118 of the battery 110, and side arms 152 extending vertically from opposite end portions of the cross bar 150. The side arms 152 can each include a threaded post 154 connected to the cross bar 150 by threaded fastener (e.g., a nut) 155 and extending vertically from the cross bar 150, and a connection member 156 connecting the threaded post 154 to the side panels 134 and 144 of the battery mount 120. Thus, the cross bar 150 and the side arms 152 can be adjusted, by threading the threaded fasteners 155 on the threaded posts 154, to press the battery 110 downward on the outer and inner trays 130 and 140.

As shown in FIGS. 1A, 1B, and 1D, the battery mount 120 can further include an end brace 122 that is attached to an end portion of the top panel 188 of the ballast mount 160. The end brace 122 can be attached to an end panel 136 of the bottom tray 130 to help secure the battery mount 120 on the ballast mount 160, and form a barrier to retain one end of the battery 110.

As illustrated in FIG. 1D, the ballast mount 160 can include a bottom mount member 170 and a top mount member 180 that interconnect to form a hollow container (or ballast box) 161. In the illustrated embodiment, the hollow container 161 is a rectangular container. However, the hollow container 161 is not limited to having the form of a rectangular container, and various other polygonal shapes are possible. The bottom mount member 170 can include a bottom panel 172 of the hollow container 161 and end panels 176 of the hollow container 161 that are integrally formed with the bottom panel 172. The top mount member 180 can include the top panel 188 of the hollow container 161 and side panels 184 of the hollow container 161 that are integrally formed with the top panel 188.

The hollow container 161 can be secured to a floor or other surface of a vehicle by fasteners (e.g., bolts or screws) 168 that extend through the bottom panel 172.

Referring to FIGS. 1B and 1C, the hollow container 161 includes an interior space S1 defined by the bottom panel 172, the end panels 176, the top panel 188, and the side panels 184. In some embodiments, the ballast mount 160 can include an internal support wall 162 disposed in a central region of the interior space S1. The internal support wall 162 can be connected to the bottom panel 172 and the top panel 188 of the hollow container 161, and optionally the end panels 176 and the side panels 184, to reinforce these panels.

As shown in FIG. 1B, weight members 2, such as spherical members or pellets, including but not limited to lead shot or steel shot, can be disposed in the interior space S1 to provide the battery assembly 100 with a specified weight. As shown in FIG. 1C, the hollow container 161 can include a removable door 164. The removable door 164 can be removably attached to one end panel 176 of the hollow container 161 so as to cover an opening (not shown) in the end panel 176. The removable door 164 can be removed from the end panel 176 to load the weight members 2 into the interior space S1 through the opening in the end panel 176, and can be attached to the end panel 176 to cover the opening in the end panel 176, and thereby close the interior space S1 to prevent spillage of the weight members 2 therefrom. Although FIG. 1C illustrates the removable door 164 attached to one end panel 176, the hollow container 161 is not limited to this configuration. For example, the removable door (and the corresponding opening covered by the door) can be provided in any one or more of the panel 172, the end panels 176, the top panel 188, and the side panels 184 of the hollow container 161.

The weight members 2 are not limited to lead shot or steel shot, or other spherical members or pellets, and can have any suitable size, shape, and material composition for adequately weighting the battery assembly 100. For example, the quantity, size(s), and/or material composition(s) of the weight members 2 can be selected to provide the battery assembly 100 with the specified weight. As an example, the specified weight of the battery assembly 100 can be a weight that provides a specified overall weight balance (e.g., left, right, front, and rear weight distribution) of a vehicle in which the battery assembly 100 is mounted.

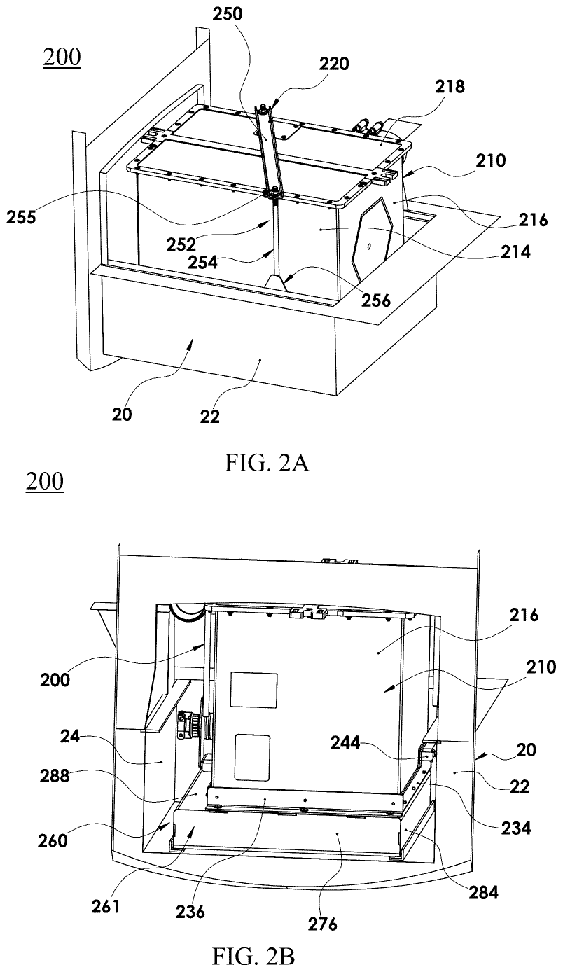

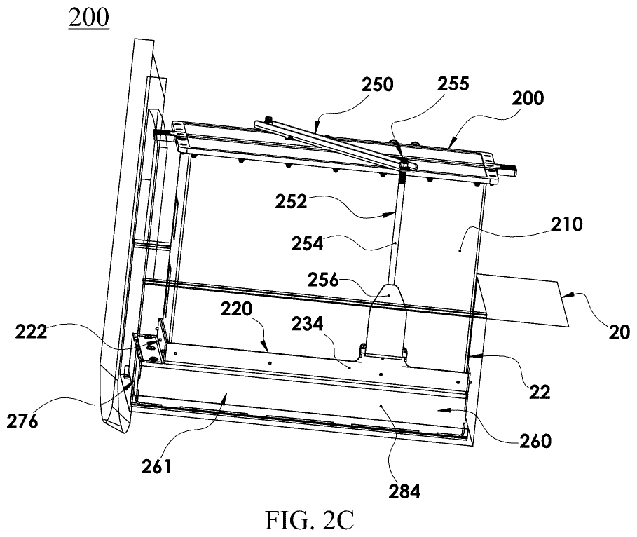

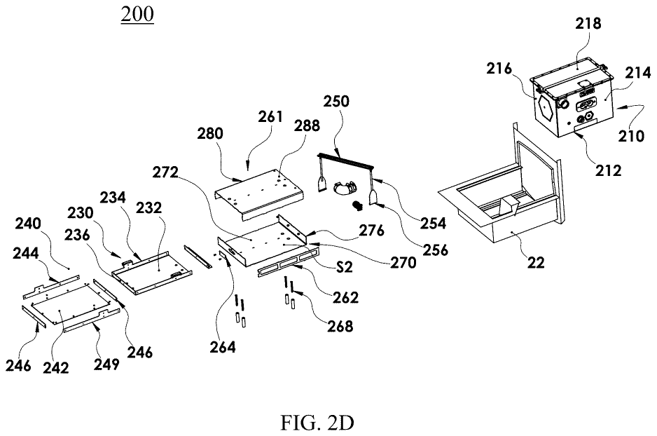

FIGS. 2A to 2D illustrate a battery assembly 200, according to an embodiment.

Referring to FIGS. 2A to 2D, the battery assembly 200 includes a battery 210, a battery mount 220, and a ballast mount 260. The ballast mount 260 is configured to be mounted on a support surface of a vehicle (e.g., an aircraft, automobile, boat, or other type of vehicle, as previously discussed herein). For example, the ballast mount 260 can be mounted on a support surface of a battery basket 20, which can be attached to an interior wall of the vehicle. The battery mount 220 is mounted on the ballast mount 260, and retains the battery 210 on the ballast mount 260.

The battery 210 can be configured to supply power to one or more systems of the vehicle. As an example, the battery 210 can be a lithium-ion battery. In the embodiment of FIGS. 2A to 2D, the battery 210 can be a 40 amp-hour lithium-ion battery. Thus, the battery assembly 200 can be suitable for 40 amp-hour lithium-ion battery installations in various aircraft or other vehicles. However, the battery 210 is not limited to a 20 amp-hour lithium-ion battery, and the battery assembly 200 is not limited to installations of such a battery.

The battery mount 220 is a tray structure configured to secure the battery 210 in position on the ballast mount 260. More specifically, the battery mount 220 can be configured to secure the battery 210 on a top panel 288 of the ballast mount 260. Referring to FIG. 2D, the battery mount 220 can include an outer tray 230 and an inner tray 240 accommodated in the outer tray 230. The outer tray 230 can include a bottom panel 232 that interfaces with and is supported on the top panel 272 of the ballast mount 260, and side panels 234 and end panels 236 extending vertically from the bottom panel 232. The inner tray 240 can include a bottom panel 242 that interfaces with and is supported on the bottom panel 232 of the outer tray 230, and side panels 244 and end panels 246 extending vertically from the bottom panel 242 to reinforce the side panels 234 and end panels 236 of the bottom tray 230, respectively. The bottom panels 232 and 242 support a bottom panel 212 of the battery 212, and the side panels 234 and 244 and the end panels 136 and 146 respectively retain side panels 214 and end panels 216 of the battery 210.

Referring to FIGS. 2A to 2D, the battery mount 220 further includes a cross bar 250 configured to interface with and retain a top panel 218 of the battery 210, and side arms 252 extending vertically from opposite end portions of the cross bar 250. The side arms 252 can each include a threaded post 254 connected to the cross bar 250 by threaded fastener (e.g., a nut) 255 and extending vertically from the cross bar 250, and a connection member 256 connecting the threaded post 254 to the side panels 234 and 244 of the battery mount 220. Thus, the cross bar 250 and the side arms 252 can be adjusted, by threading the threaded fasteners 155 on the threaded posts 254, to press the battery 210 downward on the outer and inner trays 230 and 240.

As shown in FIGS. 2B, 2C, and 2D, the battery mount 220 can further include an end brace 222 that is attached to an end portion of the top panel 288 of the ballast mount 260. The end brace 222 can be attached to an end panel 236 of the bottom tray 230 to help secure the battery mount 220 on the ballast mount 260, and form a barrier to retain one end of the battery 210.

As illustrated in FIG. 2D, the ballast mount 260 can include a bottom mount member 270 and a top mount member 280 that interconnect to form a hollow container 261. In the illustrated embodiment, the hollow container 261 is a rectangular container. However, the hollow container 261 is not limited to having the form of a rectangular container, and various other polygonal shapes are possible. The bottom mount member 270 can include a bottom panel 272 of the hollow container 261 and end panels 276 of the hollow container 261 that are integrally formed with the bottom panel 272. The top mount member 280 can include the top panel 288 of the hollow container 261 and side panels 284 of the hollow container 261 that are integrally formed with the top panel 288.

As shown in FIG. 2D, hollow container 261 can be secured to the support surface of the battery basket 20 by fasteners (e.g., bolts or screws) 268 that extend through the bottom panel 272.

Still referring to FIG. 2D, the hollow container 261 includes an interior space S2 defined by the bottom panel 272, the end panels 276, the top panel 288, and the side panels 284. In some embodiments, the ballast mount 260 can include an internal support wall 262 disposed in a central region of the interior space S2. The internal support wall 162 can be connected to the bottom panel 272 and the top panel 288 of the hollow container 261, and optionally the end panels 276 and the side panels 284, to reinforce these panels.

Weight members, such as the weight members 2 described above with respect to FIG. 1B, can be disposed in the interior space S2 to provide the battery assembly 200 with a specified weight. As shown in FIG. 2D, the hollow container 261 can include a removable door 264 and a corresponding opening covered by the removable door 264. The removable door 264 and the corresponding opening can generally correspond to the removable door 164 and the corresponding opening described above with respect to the embodiment of FIGS. 1A to 1D. Although FIG. 2D illustrates the removable door 264 attached to one end panel 276, the hollow container 261 is not limited to this configuration. For example, the removable door 264 (and the corresponding opening covered by the door) can be provided in any one or more of the panel 272, the end panels 276, the top panel 288, and the side panels 284 of the hollow container 261.

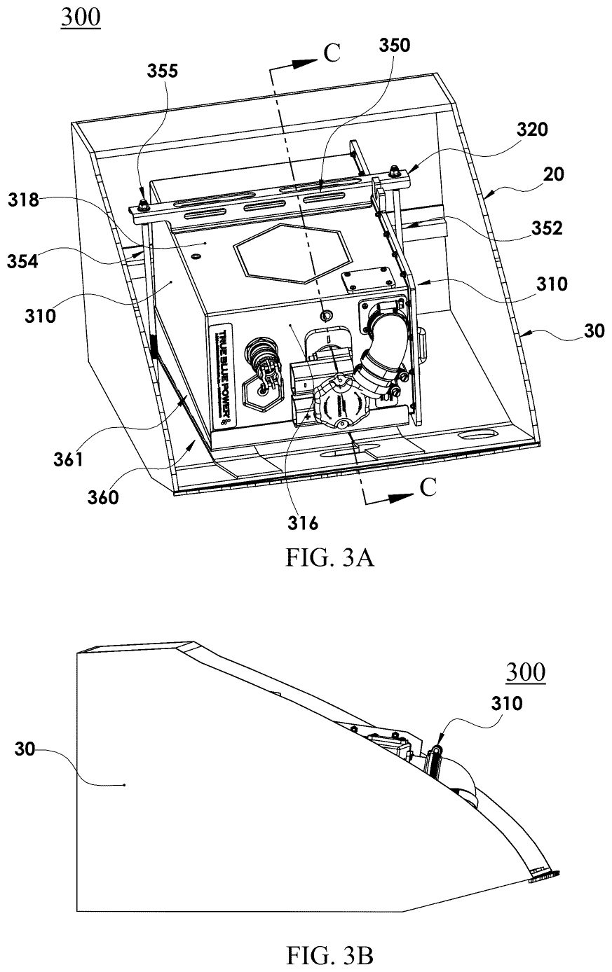

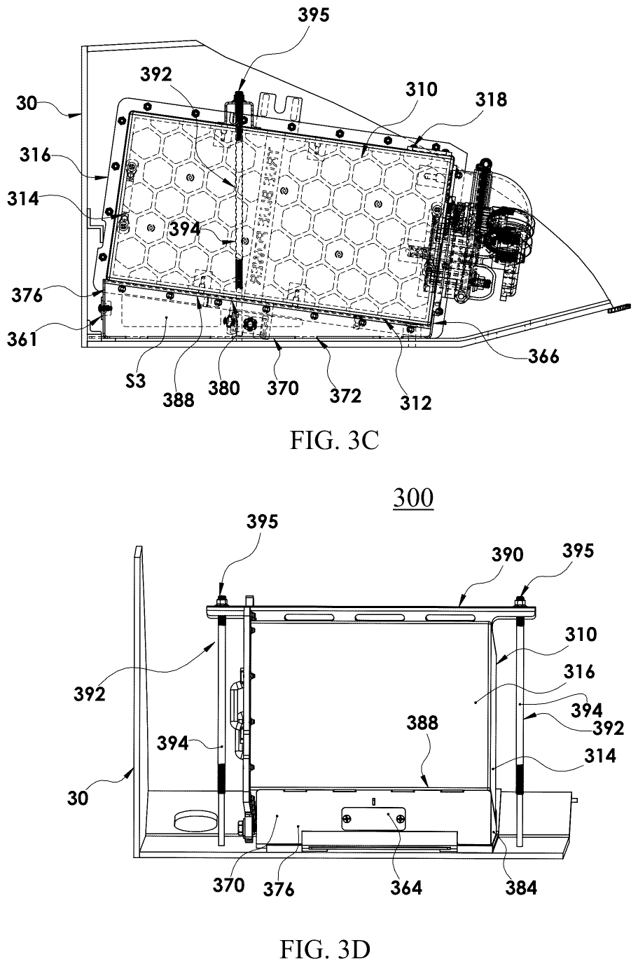

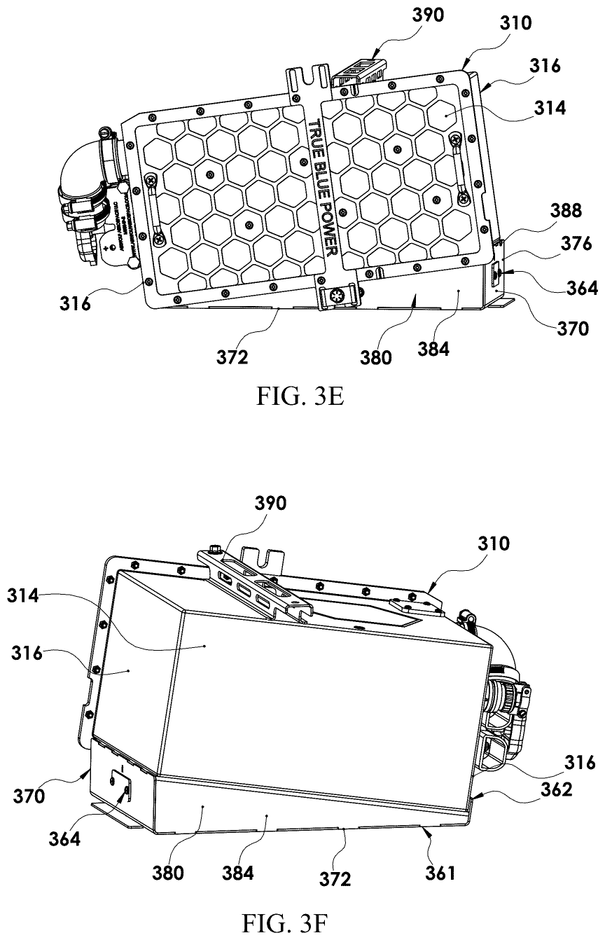

FIGS. 3A to 3D illustrate a battery assembly 300, according to an embodiment.

As shown in FIGS. 3A to 3D, the battery assembly 300 includes a battery 310 and a ballast mount 360. The ballast mount 360 is configured to be mounted on a support surface of a vehicle (e.g., an aircraft, automobile, boat, or other type of vehicle, as previously discussed herein) and retains the battery 310. For example, the ballast mount 360 can be mounted on a support surface of a battery basket 30, which can be attached to an interior wall of the vehicle. However, in other embodiments, the ballast mount 360 can be mounted on a floor of the vehicle.

The battery 310 can be configured to supply power to one or more systems of the vehicle. As an example, the battery 310 can be a lithium-ion battery. In the embodiment of FIGS. 3A to 3D, the battery 310 can be a 30 amp-hour lithium-ion battery. Accordingly, the battery assembly 300 can be suitable for 30 amp-hour lithium-ion battery installations in various aircraft or other vehicles. However, the battery 310 is not limited to a 30 amp-hour lithium-ion battery, and the battery assembly 300 is not limited to installations of such a battery.

As illustrated in FIGS. 3A and 3C to 3F, the ballast mount 360 can include a bottom mount member 370 and a top mount member 380 that interconnect to form a hollow container 361. In the illustrated embodiment, the hollow container 361 is a triangular container. That is, the hollow container 361 can have a ramp shape. However, the hollow container 361 is not limited to having the shape of a triangular container or ramp, and various other polygonal shapes are possible. The bottom mount member 370 can include a bottom panel 372 of the hollow container 361 and an end panel 376 of the hollow container 361 that is integrally formed with the bottom panel 372. The top mount member 380 can include a top panel 388 of the hollow container 361 and side panels 384 of the hollow container 361 that are integrally formed with the top panel 388.

The top panel 388 of the hollow container 361 is inclined with respect to the bottom panel 372 of the hollow container 361. The top panel 388 can be connected to the bottom panel 372 at an end of the hollow container 361 that is opposite the end panel 376. Alternatively, in some implementations, another end panel, having a height that is less than a height of the end panel 376, can be disposed opposite the end panel 376 to extend between the bottom panel 372 and the top panel 388. In some implementations, an angle of incline between the top panel 388 and the bottom panel 372 can be from about 10 degrees to about 30 degrees. However, the angle of incline between the top panel 388 and the bottom panel 372 is not limited to the range, and can be any angle greater than 0 degrees and less than 90 degrees.

As shown in FIG. 3D, the hollow container 361 can be secured to the support surface of the battery basket 30 by fasteners (e.g., bolts or screws) that extend through the bottom panel 372.

The battery 310 is retained on the top panel 388 of the hollow container 361. More specifically, a bottom panel 312 of the battery 310 rests on the top panel 388 of the hollow container 361. The ballast mount 360 can include an end brace 362 that is attached the top panel 388 to help secure the battery 310 on the top panel 388. More specifically, the end brace 362 can be positioned near a bottom of the incline of the top panel 388 at a front end region of the hollow container 361, and can engage an end panel 316 of the battery 310 to prevent the battery 310 from sliding off the top panel 388.

Referring to FIGS. 3A and 3C to 3E, the ballast mount 360 further includes a cross bar 390 configured to interface with and retain a top panel 318 of the battery 310, and side arms 392 extending vertically from opposite end portions of the cross bar 390. The side arms 392 can each include a threaded post 394 connected to the cross bar 390 by threaded fastener (e.g., a nut) 395 and extending vertically from the cross bar 350 and fixed to the support surface of the battery tray 30. Thus, the cross bar 390 and the side arms 392 can be adjusted, by threading the threaded fasteners 395 on the threaded posts 394, to press the battery 310 downward on the hollow container 361.

Referring to FIG. 3C, the hollow container 361 includes an interior space S3 defined by the bottom panel 372, the end panel 376, the top panel 388, and the side panels 384. Weight members, such as the weight members 2 described above with respect to FIG. 1B, can be disposed in the interior space S3 to provide the battery assembly 300 with a specified weight.

As shown in FIG. 3D, the hollow container 361 can include a removable door 364 and a corresponding opening covered by the removable door 364. The removable door 364 and the corresponding opening can generally correspond to the removable door 164 and the corresponding opening described above with respect to the embodiment of FIGS. 1A to 1D. Although FIG. 3D illustrates the removable door 364 attached to the end panel 376, the ballast mount 360 is not limited to this configuration. For example, the removable door 364 (and the corresponding opening covered by the door) can be provided in any one or more of the bottom panel 372, the end panel 376, the side panels 384, and the top panel 388 of the hollow container 361.

FIG. 4 illustrates a battery assembly 400, according to an embodiment. The battery assembly 400 is similar to the battery assembly 300, except that the battery assembly 400 includes a battery 410 that is smaller in size than the battery 310 of the battery assembly 300. The battery assembly 400 includes the ballast mount 360, which retains the battery 410.

The battery 410 can be configured to supply power to one or more systems of the vehicle. As an example, the battery 410 can be a lithium-ion battery. In the embodiment of FIG. 4, the battery 410 can be a 20 amp-hour lithium-ion battery. Accordingly, the battery assembly 400 can be suitable for 20 amp-hour lithium-ion battery installations in various aircraft or other vehicles. However, the battery 410 is not limited to a 20 amp-hour lithium-ion battery, and the battery assembly 400 is not limited to installations of such a battery.

Since the battery assembly 400 includes the battery 410, which is smaller in physical size and capacity than the battery 300, the ballast mount 360 is configured slightly differently to secure the battery 410 thereon. More specifically, the end brace 362 is attached the top panel 388 of the hollow container 361 to engage an end panel 416 of the battery 410, and thereby prevent the battery 410 from sliding off the top panel 388. Due to the smaller physical size of the battery 410 relative to that of the battery 310, the end brace 362 is spaced farther back from the front end of the top panel 388 in comparison with the position of the end brace 362 in the battery assembly 300.

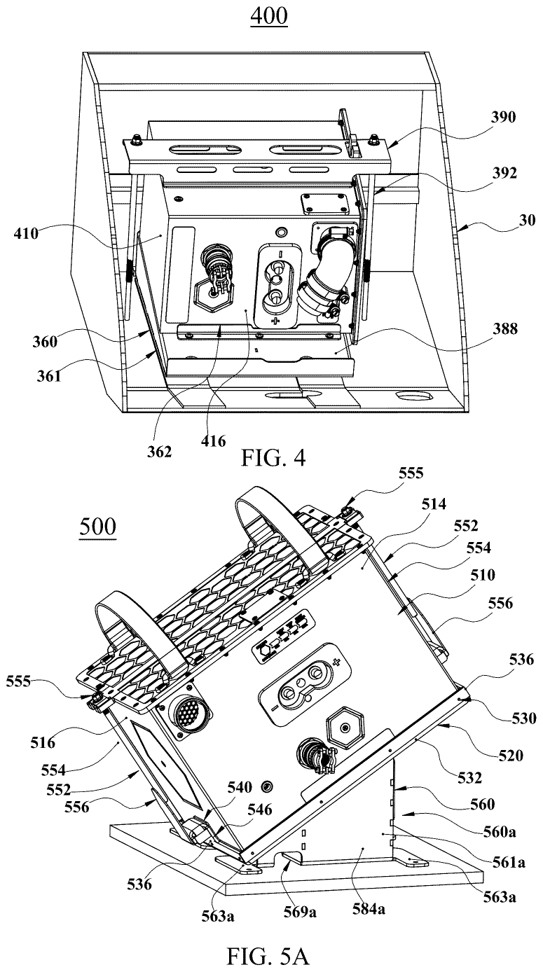

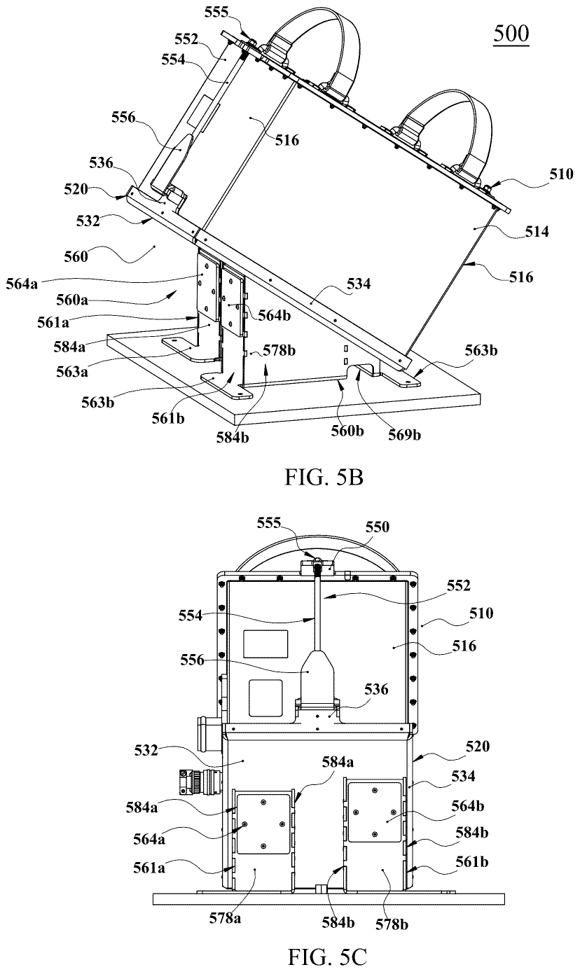

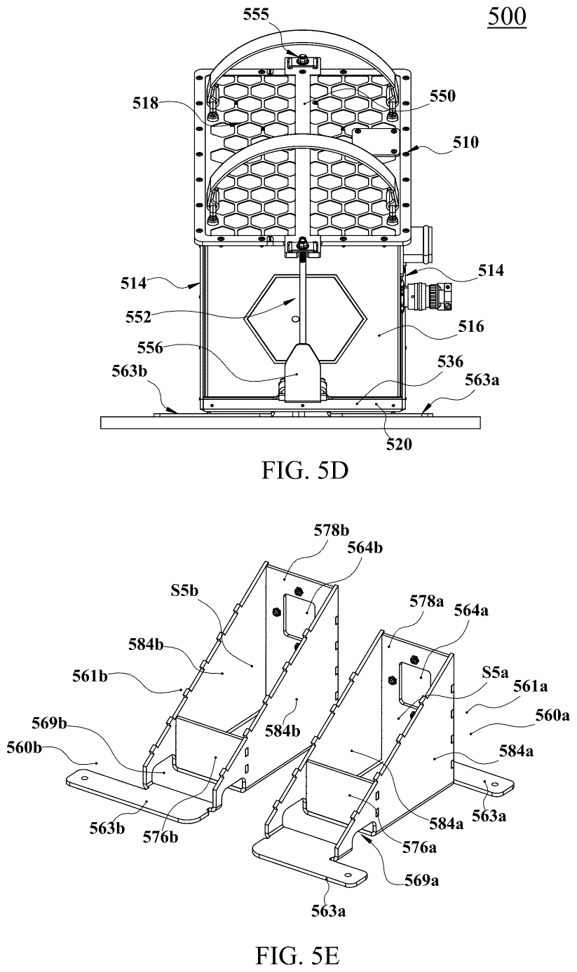

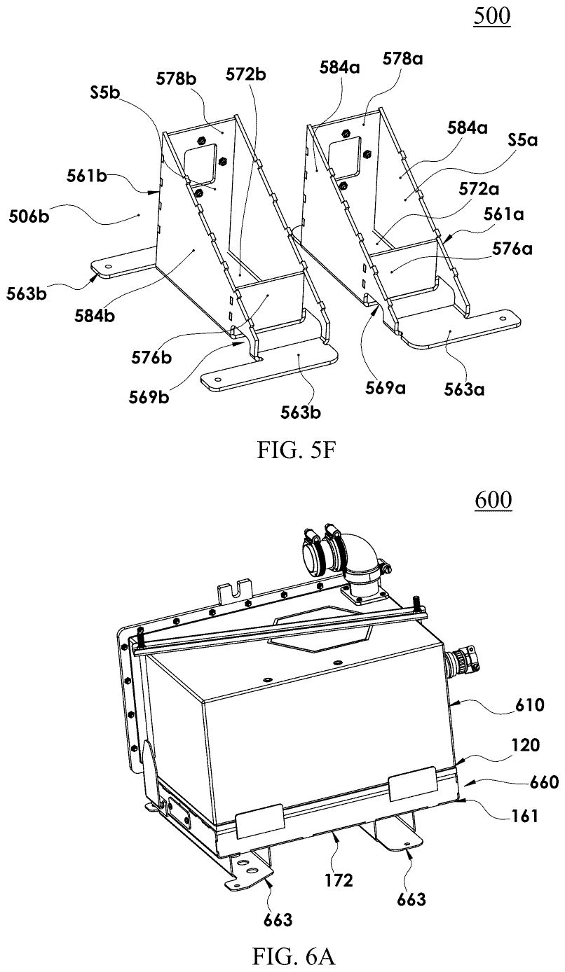

FIGS. 5A to 5E illustrate a battery assembly 500, according to an embodiment.

As shown in FIGS. 5A to 5E, the battery assembly 500 includes a battery 510, a battery mount 520, and a ballast mount 560. The ballast mount 560 is configured to be mounted on a support surface of a vehicle (e.g., an aircraft, automobile, boat, or other type of vehicle, as previously discussed herein). The battery mount 520 is mounted on the ballast mount 560, and retains the battery 510 on the ballast mount 560. The ballast mount 560 includes a first ballast mount member 560a and a second ballast mount member 560b that are laterally spaced apart to support respective portions of the battery mount 520.

The battery 510 can be configured to supply power to one or more systems of the vehicle. As an example, the battery 510 can be a lithium-ion battery. In the embodiment of FIGS. 5A to 5D, the battery 510 can be a 40 amp-hour lithium-ion battery. Therefore, the battery assembly 500 can be suitable for 40 amp-hour lithium-ion battery installations in various aircraft or other vehicles. However, the battery 510 is not limited to a 40 amp-hour lithium-ion battery, and the battery assembly 500 is not limited to installations of such a battery.

The battery mount 520 is a tray structure configured to secure the battery 510 in position on the ballast mount 560. More specifically, the battery mount 520 can be configured to secure the battery 510 on top edges of side panels 584a of the first ballast mount member 560a and side panels 584b of the second ballast mount member 560b. Referring to FIG. 5A, the battery mount 520 can include an outer tray 530 and an inner tray 540 accommodated in the outer tray 530. The outer tray 530 can include a bottom panel 532, and side panels 534 and end panels 536 extending vertically from the bottom panel 532. The inner tray 540 can include a bottom panel (not shown) and side panels (not shown), and end panels 546 generally corresponding to the bottom panel 532, side panels 534, and end panels 536 of the outer tray 530. Thus, the outer tray 530 and the inner tray 540 can have structures and functions similar to those of the outer tray 130 and the inner tray 140 in the embodiment of FIGS. 1A to 1D, with the exception that the end panels 536 and 546 are configured to be attached to side arms 552 of the battery mount 520. The bottom panel 532 of the outer tray 530 is rests on the top edges of the side panels 584a of the first ballast mount member 560a and the top edges of side panels 584b of the second ballast mount member 560b. Thus, the battery 510 is supported in an inclined orientation on the battery mount 520 and the first and second ballast mount members 560a and 560b.

Referring to FIGS. 5A to 5D, the battery mount 520 further includes a cross bar 550 configured to interface with and retain a top panel 518 of the battery 510, and the side arms 552 extending vertically from opposite end portions of the cross bar 550. The side arms 552 can each include a threaded post 554 connected to the cross bar 550 by threaded fastener (e.g., a nut) 555 and extending vertically from the cross bar 550, and a connection member 556 connecting the threaded post 554 to the end panels 536 and 546 of the battery mount 520. Thus, the cross bar 550 and the side arms 552 can be adjusted, by threading the threaded fasteners 555 on the threaded posts 554, to press the battery 510 downward on the outer and inner trays 530 and 540.

As illustrated in FIGS. 5A to 5C, 5E, and 5F, the first ballast mount member 560a can include a bottom panel 572a, a front end panel 576a, a rear end panel 578a opposite the front end panel 576a, and side panels 584a. The bottom panel 572a, the front end panel 576a, the rear end panel 578a, and the side panels 584a form a first hollow container 561a. In the illustrated embodiment, top edges of the side panels 584a are inclined with respect to the bottom panel 572a, and the rear end panel 578a has a height that is greater than a height of the front end panel 576a. Thus, the first hollow container 561a is a trapezoidal container. That is, the first hollow container 361a can be wedge-shaped. However, the first hollow container 561a is not limited to having a wedge shape, and various other polygonal shapes are possible.

Leg members 563a can be attached to front and rear portions of the first hollow container 561a for fixing the first hollow container 561a to the support surface. The leg member 563a attached to the front portion of the first hollow container 561a can include a cut-out portion 567a that provides a space for cables or wires to pass through.

Referring to FIGS. 5E and 5F, the first hollow container 561a includes a first interior space S5a defined by the bottom panel 572a, the front and rear end panels 576a and 578a, and the side panels 584a. The first interior space S5a is closed at its top by the bottom panel 532 of the outer tray 530 of the battery mount 520. Weight members, such as the weight members 2 described above with respect to FIG. 1B, can be disposed in the first interior space S5a to provide the battery assembly 500 with a specified weight.

As shown in FIGS. 5B, 5C, 5E, and 5F, the first hollow container 561a can include a removable door 564a and a corresponding opening covered by the removable door 564a. The removable door 564a and the corresponding opening can generally correspond to the removable door 164 and the corresponding opening described above with respect to the embodiment of FIGS. 1A to 1D. Although the removable door 564a is illustrated as being attached to the rear end panel 578a, the first ballast mount member 560a is not limited to this configuration. For example, the removable door 564a (and the corresponding opening covered by the removable door 564a) can be provided in any one or more of the bottom panel 572a, the front end panel 576a, the rear end panel 578a, and the side panels 584a, of the first hollow container 561a.

Referring again to FIGS. 5A to 5C, 5E, and 5F, the second ballast mount member 560b can include a bottom panel 572b, a front end panel 576b, a rear end panel 578b opposite the front end panel 576b, and side panels 584b. The bottom panel 572b, the front end panel 576b, the rear end panel 578b, and the side panels 584b form a second hollow container 561b. In the illustrated embodiment, top edges of the side panels 584b are inclined with respect to the bottom panel 572b, and the rear end panel 578b has a height that is greater than a height of the front end panel 576b. Thus, the second hollow container 561b is a trapezoidal container, and can have a shape similar to that of the first hollow container 561a. That is, the second hollow container 361b can be wedge-shaped. However, the second hollow container 561b is not limited to having a wedge shape, and various other polygonal shapes are possible.

Leg members 563b can be attached to front and rear portions of the second hollow container 561b for fixing the second hollow container 561b to the support surface. The leg member 563b attached to the front portion of the second hollow container 561b can include a cut-out portion 567b that provides a space for cables or wires to pass through.

Referring to FIGS. 5E and 5F, the second hollow container 561b includes a second interior space S5b defined by the bottom panel 572b, the front and rear end panels 576b and 578b, and the side panels 584b. The second interior space S5b is closed at its top by the bottom panel 532 of the outer tray 530 of the battery mount 520. Weight members, such as the weight members 2 described above with respect to FIG. 1B, can be disposed in the second interior space S5b to provide the battery assembly 500 with the specified weight.

As shown in FIGS. 5B, 5C, 5E, and 5F, the second hollow container 561b can include a removable door 564b and a corresponding opening covered by the removable door 564b. The removable door 564a and the corresponding opening can generally correspond to the removable door 164 and the corresponding opening described above with respect to the embodiment of FIGS. 1A to 1D. Although the removable door 564b is illustrated as being attached to the rear end panel 578b, the second ballast mount member 560b is not limited to this configuration. For example, the removable door 564b (and the corresponding opening covered by the removable door 564a) can be provided in any one or more of the bottom panel 572b, the front end panel 576b, the rear end panel 578b, and the side panels 584b, of the second hollow container 561b.

Because the ballast mount 560 includes the separate first and second ballast mount members 560a and 560b, the ballast mount 560 can be configured to support battery mounts 520 of various sizes. For example, the lateral spacing between first and second ballast mount members 560a and 560b can be changed to accommodate outer trays 530 and inner trays 540 having various widths. In some implementations, the second ballast mount member 560b can have a height that is greater than a height of the first ballast mount member 560a, and the first and second ballast mount members 560a and 560b can be offset from each other in the front-to-rear direction of the battery assembly 500. This configuration enables to battery assembly 500 to be installed in irregularly shaped spaces.

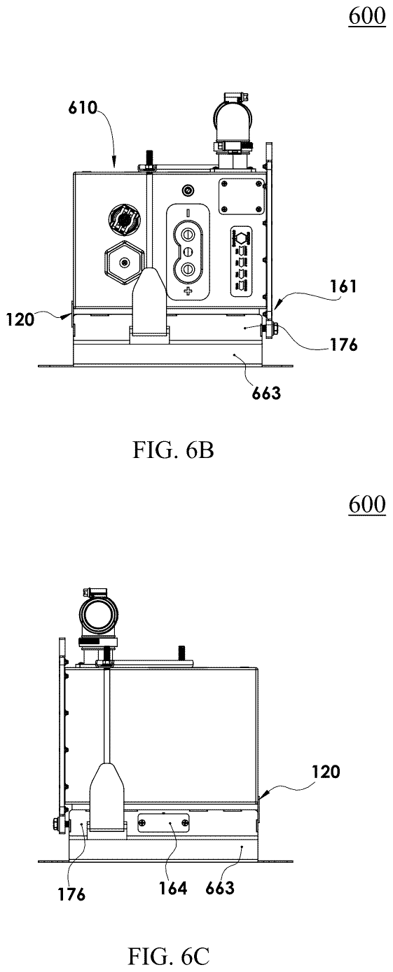

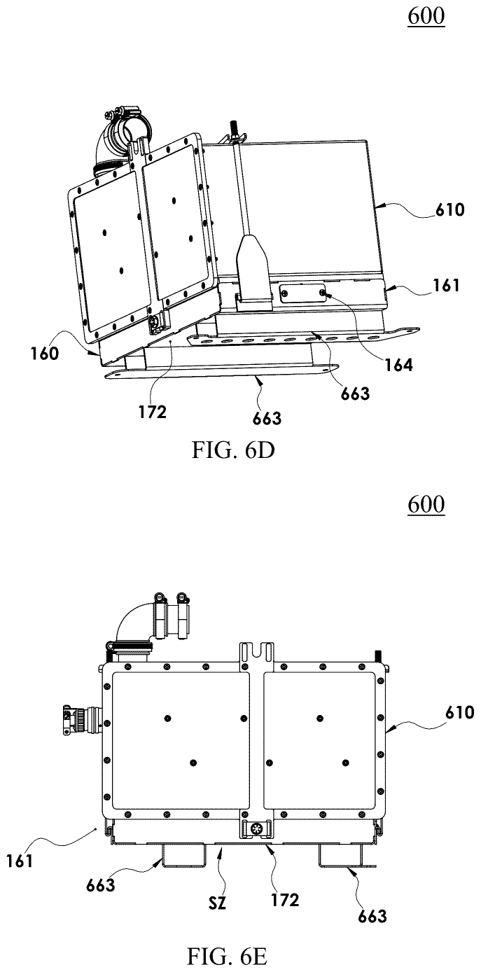

FIGS. 6A to 6E illustrate a battery assembly 600, according to an embodiment.

Referring to FIGS. 6A to 6E, the battery assembly 600 includes the battery 110, the battery mount 120, and a ballast mount 660. The ballast mount 660 is similar to the ballast mount 160 of FIGS. 1A to 1D, except that the hollow container 161 is mounted on a pair of laterally extending legs 663. More specifically, the bottom panel 172 of the hollow container 161 is fixed to the legs 663.

The legs 663 can be elongate channel members having a U-shaped or C-shaped cross-section, for example. However, other shapes are possible for the legs 663. The legs 663 can be fastened to a support surface of a vehicle to mount the battery assembly 600 in the vehicle. The legs 663 elevate the hollow container 161 such that the hollow container 161 is positioned above and the support surface, and a space SZ is formed between the bottom panel 172 of the hollow container 161 and the support surface. Thus, cables, wires, and other components of the vehicle can be passed through or otherwise disposed in the space SZ.

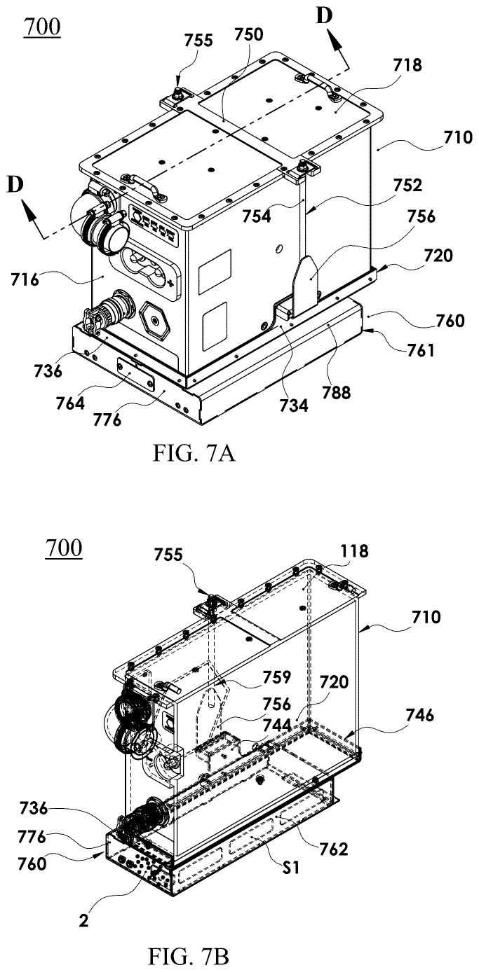

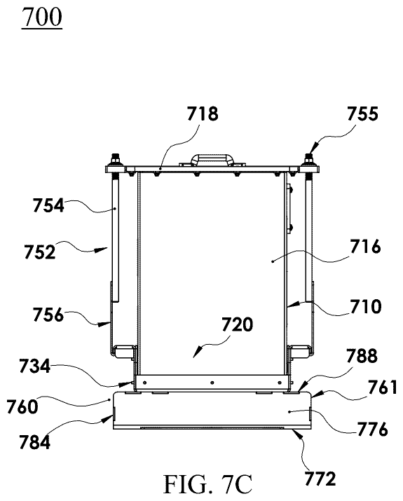

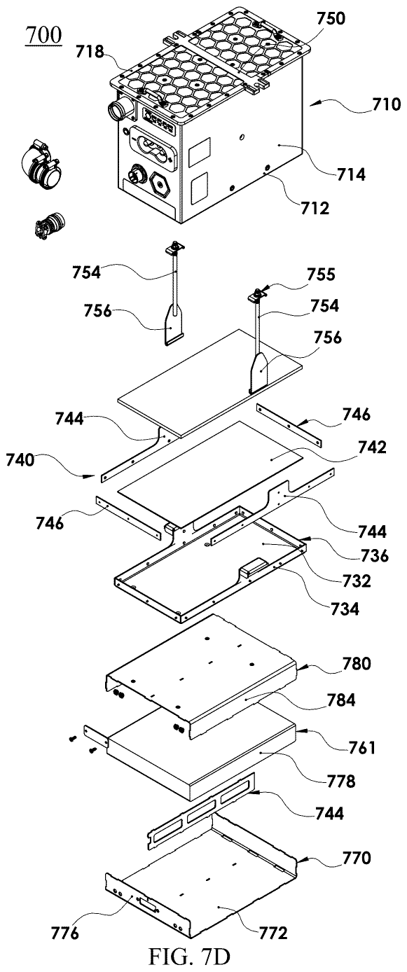

FIGS. 7A to 7D illustrate a battery assembly 700, according to an embodiment. The battery assembly 700 can be configured for installation in a vehicle. For example, the vehicle can be an aircraft. More specifically, in some implementations, the vehicle can be an airplane or a helicopter. However, the vehicle is not limited to an aircraft, and may be any other type of vehicle, such as an automobile or boat.

As shown in FIGS. 7A to 7D, the battery assembly 700 includes a battery 710, a battery mount 720, and a ballast mount 760. The ballast mount 760 is configured to be mounted on a support surface of the vehicle. The battery mount 720 is mounted on the ballast mount 760, and retains the battery 710 on the ballast mount 760.

The battery 710 can be configured to supply power to one or more systems of the vehicle. As an example, the battery 710 can be a lithium-ion battery. In the embodiment of FIGS. 7A and 7B, the battery 710 can be a 30 amp-hour lithium-ion battery. Accordingly, the battery assembly 700 can be suitable for 30 amp-hour lithium-ion battery installations in various aircraft or other vehicles. However, the battery 710 is not limited to a 30 amp-hour lithium-ion battery, and the battery assembly 700 is not limited to installations of such a battery.

The battery mount 720 is a tray structure configured to secure the battery 710 in position on the ballast mount 760. More specifically, the battery mount 720 can be configured to secure the battery 710 on a top panel 788 of the ballast mount 760. Referring to FIG. 7D, the battery mount 720 can include an outer tray 730 and an inner tray 740 accommodated in the outer tray 730. The outer tray 730 can include a bottom panel 732 that interfaces with and is supported on the top panel 788 of the ballast mount 760, and side panels 734 and end panels 736 extending vertically from the bottom panel 732. The inner tray 640 can include a bottom panel 742 that interfaces with and is supported on the bottom panel 732 of the outer tray 730, and side panels 744 and end panels 746 extending vertically from the bottom panel 742 to reinforce the side panels 734 and end panels 736 of the bottom tray 730, respectively. The bottom panels 732 and 742 support a bottom panel 762 of the battery 762, and the side panels 734 and 744 and the end panels 736 and 746 respectively retain side panels 714 and end panels 716 of the battery 710.

Referring to FIGS. 7A to 7D, the battery mount 720 further includes a cross bar 750 configured to interface with and retain a top panel 718 of the battery 710, and side arms 752 extending vertically from opposite end portions of the cross bar 750. The side arms 752 can each include a threaded post 754 connected to the cross bar 750 by threaded fastener (e.g., a nut) 755 and extending vertically from the cross bar 750, and a connection member 756 connecting the threaded post 754 to the side panels 734 and 744 of the battery mount 720. Thus, the cross bar 750 and the side arms 752 can be adjusted, by threading the threaded fasteners 755 on the threaded posts 754, to press the battery 710 downward on the outer and inner trays 730 and 740.

As illustrated in FIG. 7D, the ballast mount 760 can include a bottom mount member 770 and a top mount member 780 that interconnect to form a hollow container (or ballast box) 761. An inner tray 778 can also be provided inside the bottom mount member 770 and the top mount member 780. In the illustrated embodiment, the hollow container 761 is a rectangular container. However, the hollow container 761 is not limited to having the form of a rectangular container, and various other polygonal shapes are possible. The bottom mount member 770 can include a bottom panel 772 of the hollow container 761 and end panels 776 of the hollow container 761 that are integrally formed with the bottom panel 772. The top mount member 780 can include the top panel 788 of the hollow container 761 and side panels 784 of the hollow container 761 that are integrally formed with the top panel 788.

The hollow container 761 can be secured to a floor or other surface of a vehicle by fasteners (e.g., bolts or screws) that extend through the bottom panel 772.

Referring to FIGS. 7B and 7C, the hollow container 761 includes an interior space S1 defined by the bottom panel 772, the end panels 776, the top panel 788, and the side panels 784. In some embodiments, the ballast mount 760 can include an internal support wall 762 disposed in a central region of the interior space S1. The internal support wall 762 can be connected to the bottom panel 772 and the top panel 688 of the hollow container 761, and optionally the end panels 776 and the side panels 784, to reinforce these panels.

As shown in FIG. 7B, weight members 2, such as lead shot or steel shot, can be disposed in the interior space S1 to provide the battery assembly 700 with a specified weight. As shown in FIG. 7A, the hollow container 761 can include a removable door 764. The removable door 764 can be removably attached to one end panel 776 of the hollow container 761 so as to cover an opening (not shown) in the end panel 776. The removable door 764 can be removed from the end panel 776 to load the weight members 2 into the interior space S1 through the opening in the end panel 776, and can be attached to the end panel 776 to cover the opening in the end panel 776, and thereby close the interior space S1 to prevent spillage of the weight members 2 therefrom. Although FIG. 7C illustrates the removable door 764 attached to one end panel 776, the hollow container 761 is not limited to this configuration. For example, the removable door (and the corresponding opening covered by the door) can be provided in any one or more of the panel 772, the end panels 776, the top panel 788, and the side panels 784 of the hollow container 761.

The quantity, size(s), and/or material composition(s) of the weight members 2 can be selected to provide the battery assembly 700 with a specified weight. As an example, the specified weight of the battery assembly 700 can be a weight that provides a specified overall weight balance (e.g., left, right, front, and rear weight distribution) of a vehicle in which the battery assembly 700 is mounted.

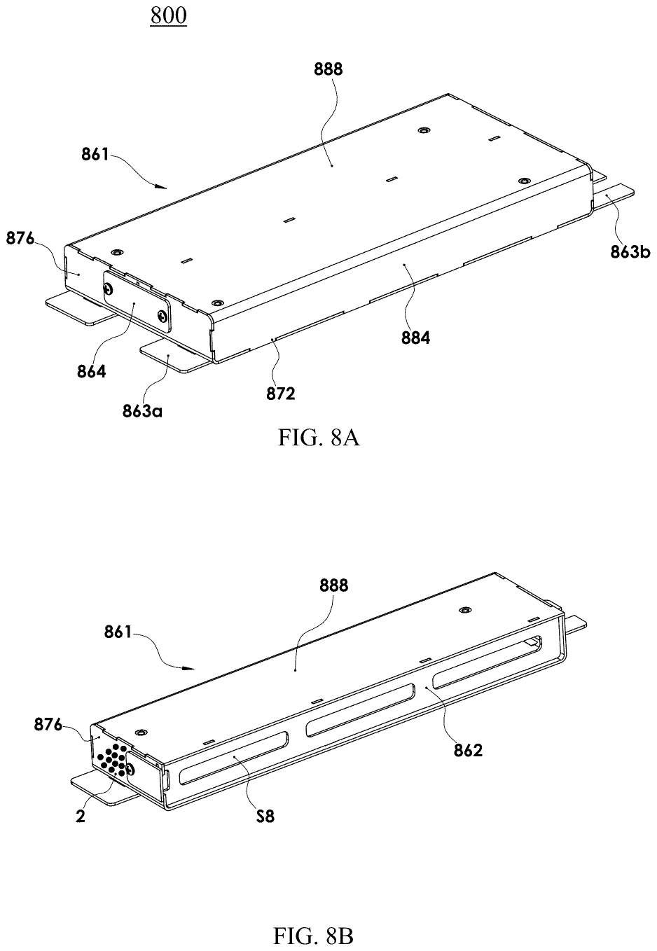

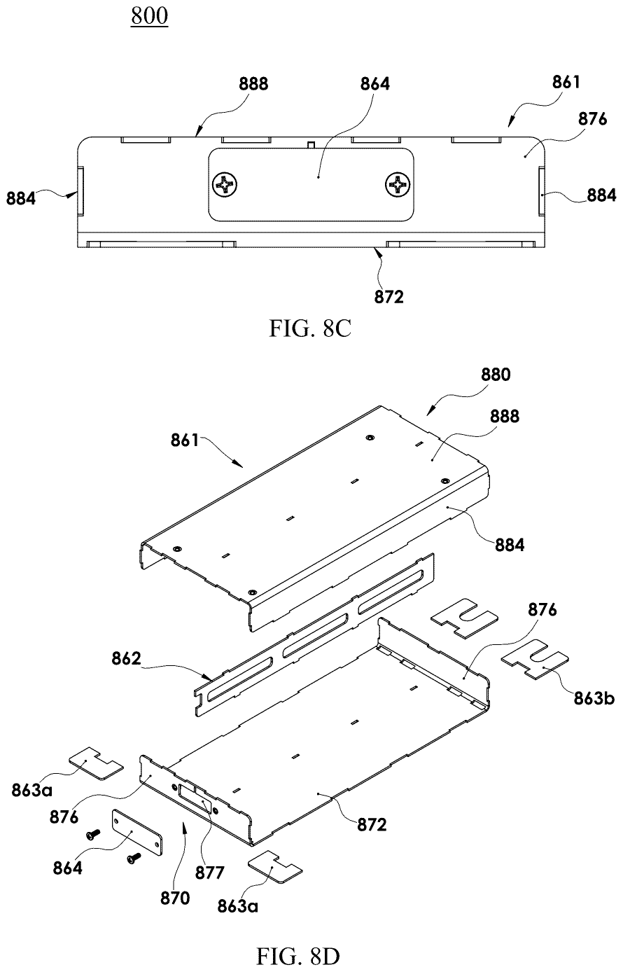

FIGS. 8A to 8D illustrate a ballast box 861, according to an embodiment. The ballast box 861 can be configured for installation in a vehicle. For example, the vehicle can be an aircraft, such as an airplane or a helicopter. However, the vehicle is not limited to an aircraft, and may be any other type of vehicle, such as an automobile or a boat. In some implementations, the ballast box 861 can be shaped and dimensioned to be installed in a battery compartment of a vehicle. In some implementations in which an aircraft includes two battery compartments for receiving batteries to power one or more systems of the aircraft, a battery can be mounted in a first one of the two battery compartments, and the ballast box 861 can be mounted in a second one of the two battery compartments to adjust a CG of the aircraft.

As shown in FIGS. 8A to 8D, the ballast box 861 is a hollow container and can include a bottom mount member 870 and a top mount member 880 that interconnect with each other. In the illustrated embodiment, the ballast box 861 is a rectangular container. However, ballast box 861 is not limited to having the form of a rectangular container, and various other polygonal shapes are possible. As shown in FIG. 8D, the bottom mount member 870 can include a bottom panel 872 of the ballast box 861 and end panels 876 of the ballast box 861 that are integrally formed with the bottom panel 872. The top mount member 880 can include the top panel 888 of the ballast box 861 and side panels 884 of the ballast box 861 that are integrally formed with the top panel 888.

The ballast box 861 can include support legs 863a and 863b for stabilizing the ballast box 861 on a surface of a vehicle. The support legs 863a and 863b can respectively extend from opposite ends of the ballast box 861. For example, the ballast box 861 can be secured to a floor of a battery compartment or other surface of the vehicle by fasteners (e.g., bolts or screws) that extend through one or more of the support legs 863a and 863b. Alternatively, the support legs 863a and 863b can be welded or bonded to the floor or other support surface.

Referring to FIG. 8B, the hollow container 766 includes an interior space S8 defined by the bottom panel 872, the end panels 876, the top panel 888, and the side panels 884. In some embodiments, the ballast box 861 can include an internal support wall 862 disposed in a central region of the interior space S8. The internal support wall 862 can be connected to the bottom panel 872 and the top panel 888, and optionally the end panels 876 and the side panels 884, to reinforce these panels.

As shown in FIG. 8B, the weight members 2 can be disposed in the interior space S8 to provide the ballast box 861 with a specified weight. As shown in FIGS. 8C and 8D, the ballast box 861 can include a removable door 864. The removable door 864 can be removably attached to one end panel 876 of the ballast box 861 so as to cover an opening 877 in the end panel 876. The removable door 864 can be removed from the end panel 876 to load the weight members 2 into the interior space S8 through the opening 877 in the end panel 876, and can be attached to the end panel 876 to cover the opening 877 in the end panel 876, and thereby close the interior space S8 to prevent spillage of the weight members 2 therefrom. Although FIG. 8C illustrates the removable door 864 attached to one end panel 876, the ballast box 861 is not limited to this configuration. For example, the removable door (and the corresponding opening covered by the door) can be provided in any one or more of the panel 872, the end panels 876, the top panel 888, and the side panels 884 of the ballast box 861.

For example, the quantity, size(s), and/or material composition(s) of the weight members 2 can be selected to provide the ballast box 861 with a specified weight. As an example, the specified weight of the ballast box 861 can be a weight that provides a specified overall weight balance (e.g., left, right, front, and rear weight distribution) of a vehicle in which the ballast box 861 is mounted.

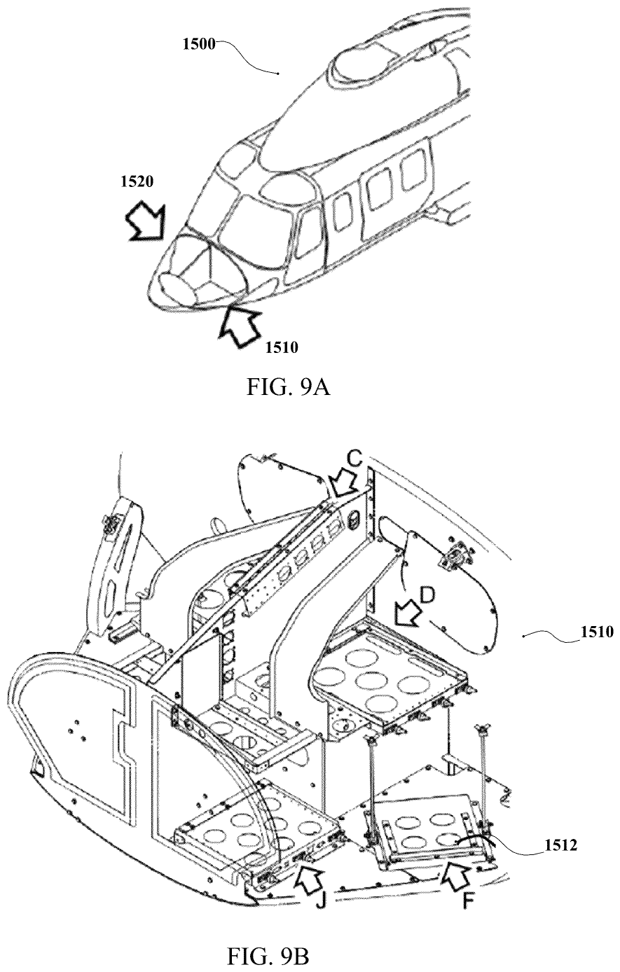

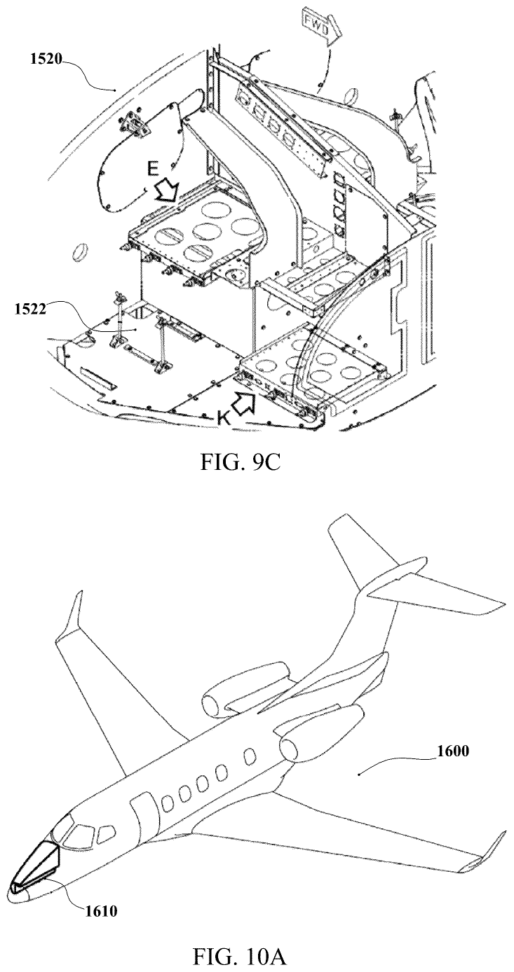

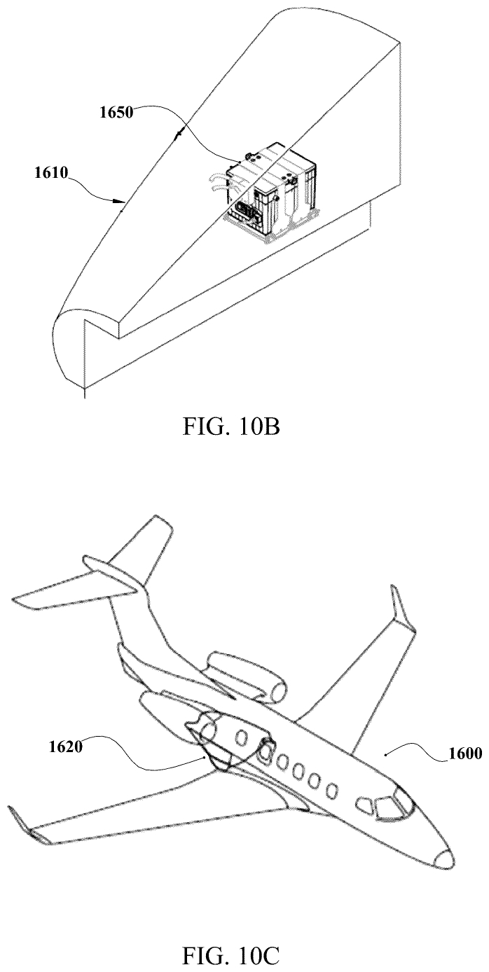

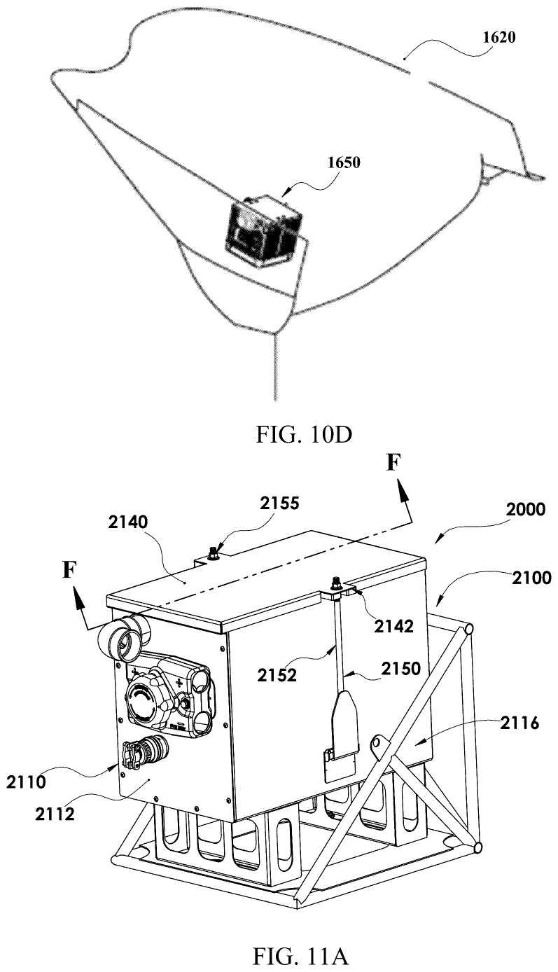

As discussed in more detail below, FIGS. 9A to 9C and FIGS. 10A to 10D illustrate embodiments of a helicopter and an airplane, respectively, that include two battery compartments in which the ballast box 861 of FIGS. 8A to 8D can be selectively mounted.

FIGS. 9A to 9C illustrate a portion of a helicopter 1500 including a first (e.g., left) battery compartment 1510 and a second (e.g., right) battery compartment 1520 in a nose of the helicopter 1500. For example, in some embodiments, a battery can be mounted in either one of a location 1512 of the first battery compartment 1510 and a location 1522 of the second battery compartment 1520, and the ballast box 861 of FIGS. 8A to 8D can be mounted in the other one of the location 1512 and the location 1522 to adjust the CG of the helicopter 1500.

FIGS. 10A to 10D illustrate an airplane 1600 including a first (e.g., nose) battery compartment 1610 and a second (e.g., fuselage) battery compartment 1620. For example, in some embodiments, a battery 1650 can be mounted in either one of the first battery compartment 1610 and the second battery compartment 1620, and the ballast box 861 of FIGS. 8A to 8D can be mounted in the other one of the first battery compartment 1610 and the second battery compartment 1620 to adjust the CG of the airplane 1600.

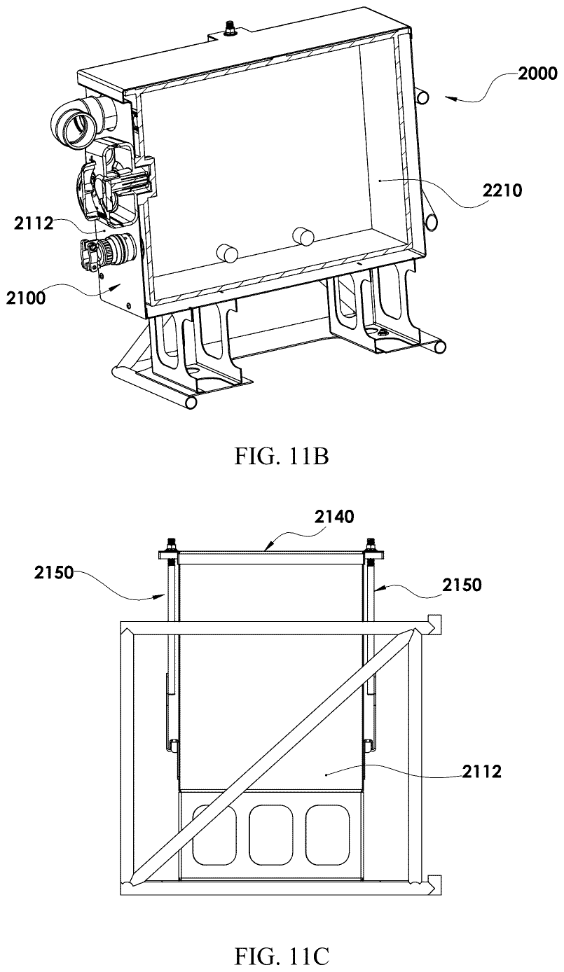

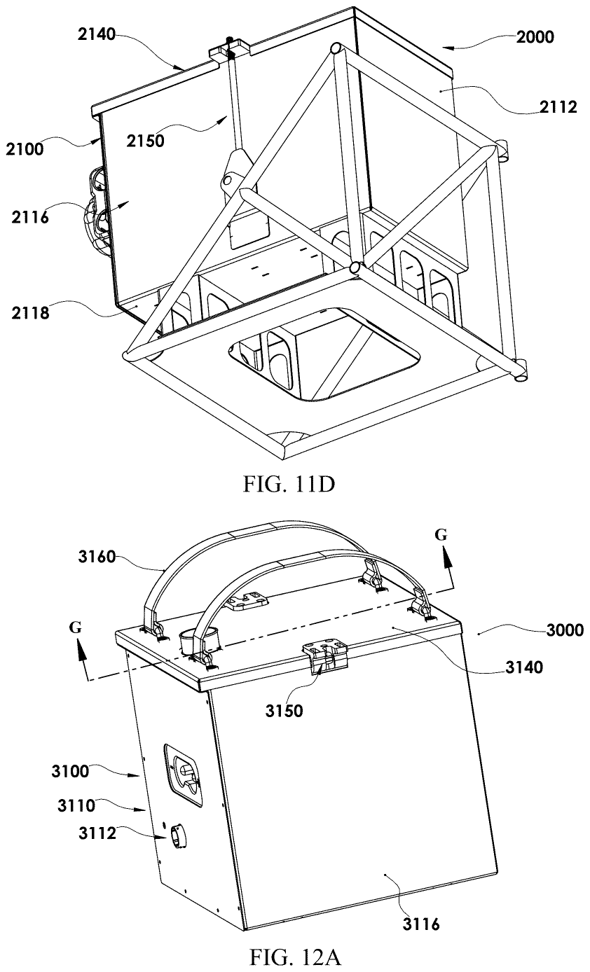

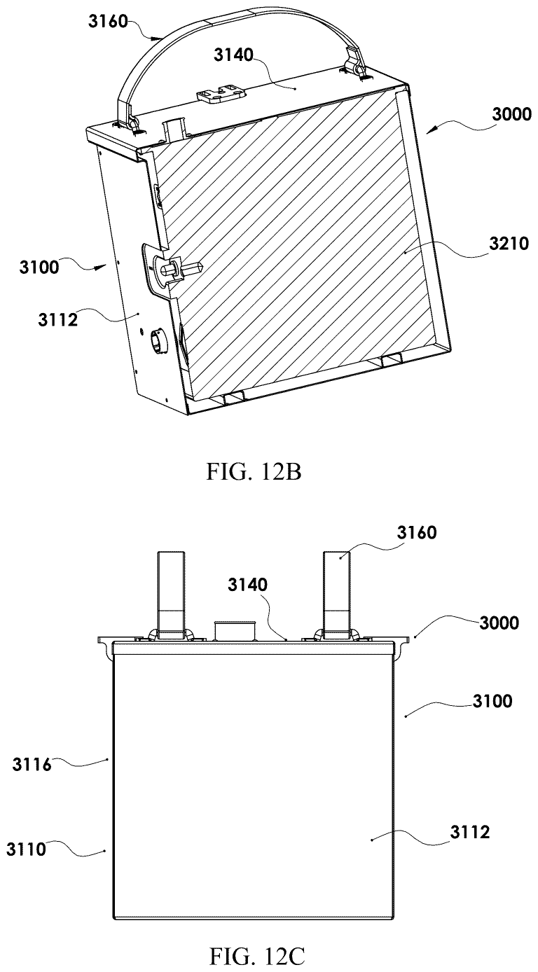

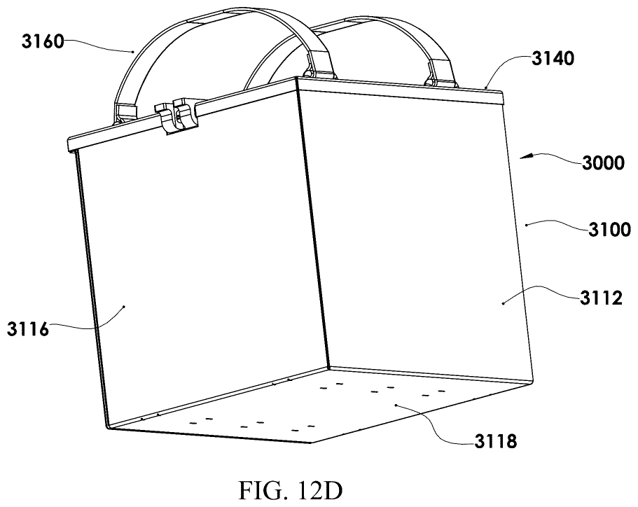

According to current FAA rules, no lithium batteries are allowed in the engine compartment of an aircraft unless they can pass the flame tests of 2000° F. for 15 minutes. As lithium batteries have an aluminum outer case/shell, they will not pass this test required by the FAA. Thus, to address this issue, in some embodiments, a stainless steel enclosure is provided to enclose a lithium ion battery in an aircraft. The stainless steel enclosures disclosed herein are capable of withstanding temperatures of 2000° F. for greater than 15 minutes, and thus enable aluminum-cased lithium ion batteries to be mounted in engine compartments of aircraft. Example embodiments of stainless steel enclosures for lithium ion batteries in an aircraft are described below with reference to FIGS. 11A to 11D and FIGS. 12A to 12D.

FIGS. 11A to 11D illustrate a battery assembly 2000 including a stainless steel case 2100 and a lithium ion battery 2210 enclosed in the stainless steel case 2100. In some embodiments, the lithium ion battery 2210 can be, for example a 20 amp-hour battery, a 30 amp-hour battery, or a 40 amp-hour battery. However, the lithium ion battery 2210 is not limited to the aforementioned capacities/sizes, and can be of any other capacity/size. The stainless steel case 2100 includes a bottom case 2110 and a lid 2140 configured to be secured to a top of the bottom case 2110.

For example, the bottom case 2110 can include end panels 2112, side panels 2116, and a bottom panel 2118 to retain the lithium ion battery 2210 therein.

The lid 2140 can be secured to the bottom case 2110 by arm members 2150 that include threaded posts 2152. First ends of threaded posts 2152 can be received in threaded mounts 2142 on the lid 2140, and can be secured to the threaded mounts 2142 by fasteners (e.g., nuts) 2155. Second ends of the threaded posts 2152 can be attached to the side panels 2116 of the bottom case 2110.

FIGS. 12A to 12D illustrate a battery assembly 3000 including a stainless steel case 3100 and a lithium ion battery 3210 enclosed in the stainless steel case 3100. In some embodiments, the lithium ion battery 3210 can be, for example a 50 amp-hour battery. However, the lithium ion battery 3210 is not limited to a 50 amp-hour capacity/size, and can be of any other capacity/size. The stainless steel case 3100 includes a bottom case 3110 and a lid 3140 configured to be secured to a top of the bottom case 3110.

For example, the bottom case 3110 can include end panels 3112, side panels 3116, and a bottom panel 3218 to retain the lithium ion battery 3210 therein.

The lid 3140 can be secured to the bottom case 3110 by arm members 3150 on the lid 3140 and the top of the side panels 3116.

The lid 3140 can further include straps 3160 attached to the top surface of the lid 3140 to facilitate carrying or handling of the battery assembly 3000 by an operator.

Although not explicitly illustrated, the stainless steel enclosures 2000 and 3000 of FIGS. 11A to 11D and 12A to 12D can also be implemented to enclose batteries mounted using any of the various ballast mounts disclosed herein.

The battery assemblies, ballast mounts, and ballast boxes disclosed herein provide a time-saving and cost-effective way to maintain a proper CG range of a vehicle. For example, when a weight distribution/CG of a vehicle changes due to a change of the battery or a change in the weight and/or weight distribution of occupants, equipment, and/or accessories, inexpensive weight members (such as lead shot or steel shot) can be loaded in or removed from the ballast mount/ballast box to maintain a proper CG range of the vehicle. Since the disclosed battery assemblies, ballast mounts, and ballast boxes constrain the addition and subtraction of weight in the ballast mount/ballast box to one location of the vehicle, the disclosed battery assemblies eliminate the need for time-consuming recalculations of CG that are currently required when adding, removing and/or relocating weights to compensate for changes in CG of the vehicle.

Although the ballast mounts and battery mounts disclosed herein are described as supporting a battery of a vehicle, the disclosed ballast mounts and battery mounts can be implemented in various assemblies to support other devices mounted in a vehicle/aircraft, such as, but not limited to avionics, a pump, and a rack.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery assembly, comprising:
a battery for supplying power to one or more systems of a vehicle;
a ballast mount configured to be mounted on a support surface of the vehicle, the ballast mount comprising an interior space configured to receive one or more weight members; and
a battery mount mounted on the ballast mount, and configured to retain the battery.

2. The battery assembly of claim 1, wherein the battery is a lithium ion battery.

3. The battery assembly of claim 1, wherein the ballast mount further comprises a door configured to be opened for loading the one or more weight members into the interior space.

4. The battery assembly of claim 1, wherein the ballast mount further comprises:
a bottom panel configured to interface with the support surface of the vehicle;
a top panel configured to support the battery mount thereon;
side panels connected to the top wall and the bottom wall; and
at least one end panel connected to the top panel, the bottom panel, and the side panels.

5. The battery assembly of claim 4, wherein the top panel is inclined with respect to the bottom panel.

6. The battery assembly of claim 4, wherein the ballast mount further comprises an internal support wall disposed in a central region of the interior space, and wherein the internal support wall is connected to the top panel and the bottom panel.

7. The battery assembly of claim 6, wherein the internal support wall is further connected to the at least one end panel.

8. The battery assembly of claim 1, wherein the battery mount comprises:
a tray interfacing with a top panel of the ballast mount, the tray being configured to receive a bottom panel of the battery;
a cross bar configured to interface with a top panel of the battery; and
side arms configured connect the cross bar to the tray.

9. The battery assembly of claim 1, wherein the one or more weight members comprise spherical members or pellets.

10. A battery assembly, comprising:
a battery for supplying power to one or more systems of a vehicle; and
a ballast mount configured to retain the battery,
wherein the ballast mount is further configured to be mounted on a support surface of the vehicle, and
wherein the ballast mount comprises a hollow container including an interior space configured to receive one or more weight members.

11. The battery assembly of claim 10, wherein the battery is a lithium ion battery.

12. The battery assembly of claim 10, wherein the hollow container further comprises a door configured to be opened for loading the one or more weight members into the interior space.

13. The battery assembly of claim 10, wherein the hollow container further comprises:
a bottom panel configured to interface with the support surface of the vehicle;
a top panel configured to support the battery thereon;
side panels connected to the top wall and the bottom wall; and
at least one end panel connected to the top panel, the bottom panel, and the side panels.

14. The battery assembly of claim 13, wherein the top panel is inclined with respect to the bottom panel.

15. The battery assembly of claim 13, wherein the ballast mount further comprises an internal support wall disposed in a central region of the interior space, and wherein the internal support wall is connected to the top panel and the bottom panel.

16. The battery assembly of claim 15, wherein the internal support wall is further connected to the at least one end panel.

17. The battery assembly of claim 10, wherein the ballast mount further comprises:
a cross bar configured to interface with a top panel of the battery; and
side arms configured connect the cross bar to the hollow container and the support surface.

18. The battery assembly of claim 10, wherein the one or more weight members comprise spherical members or pellets.

19. A battery mounting assembly, comprising:
a ballast mount configured to be mounted on a support surface of a vehicle, and comprising an interior space configured to receive one or more weight members; and
a battery mount mounted on the ballast mount, and configured to retain a battery for supplying power to one or more systems of a vehicle.
